(19) United States
(12) Patent Application Publication
(10) Pub. No.: US 2014/0270826 A1
(43) Pub. Date: Sep. 18, 2014

(54) IMAGE FORMING APPARATUS

(71) Applicant: CANON KABUSHIKI KAISHA, Tokyo (JP)

(72) Inventors: Kenta Kubo, Kamakura-shi (JP); Tetsuya Atsumi, Tokyo (JP); Tomohito Ishida, Saitama-shi (JP); Megumi Uchino, Tokyo (JP); Shunichi Takada, Soka-shi (JP)

(73) Assignee: CANON KABUSHIKI KAISHA, Tokyo (JP)

(21) Appl. No.: 14/205,130

(22) Filed: Mar. 11, 2014

(30) Foreign Application Priority Data
Mar. 15, 2013 (JP) 2013-054383

(51) Int. Cl. G03G 15/00; G03G 15/09; G03G 15/06

(52) U.S. Cl. CPC G03G 15/0907
USPC 399/48; 399/270; 399/55; 399/49

(57) ABSTRACT

The image forming apparatus includes an image carrier, a developer carrier, a magnetic field generation unit that is fixedly disposed in a hollow part of the developer carrier and includes a plurality of magnetic poles disposed in a circumferential direction of the developer carrier, a conductive member disposed so as to oppose a predetermined magnetic pole, of the plurality of magnetic poles, which is located odd-number pole upstream of a magnetic pole corresponding to a developing area D in a rotational direction of the developer carrier, a power source that can apply a voltage to the conductive member, a potential detection unit configured to detect pre-development and post-development potentials of a predetermined image formed on the image carrier, and a changing unit configured to change the voltage to be applied from the power source to the conductive member based on a detection result obtained by the potential detection unit.

### BACKGROUND OF THE INVENTION

1. Field of the Invention

The present invention relates to an image forming apparatus, such as a copy machine, a printer, or a facsimile apparatus, which performs an image forming operation using a two-component developing system.

2. Description of the Related Art

In general, an electrophotographic image forming apparatus sequentially performs the following processes. First, as a charging process, the electrophotographic image forming apparatus causes a charging device to charge a photosensitive member (i.e., an image carrier). Next, as a latent image forming process, the electrophotographic image forming apparatus causes an exposure device to exposure the charged surface of the photosensitive member to light based on image information to form an electrostatic latent image (i.e., an electrostatic image) on the photosensitive member. Next, as a developing process, the electrophotographic image forming apparatus causes a developing device to develop (visualize) a toner image from the electrostatic latent image on the photosensitive member with colored toner particles of a developer. Next, as a transfer process, the electrophotographic image forming apparatus generates an electrostatic force to transfer the toner image from the surface of the photosensitive member to a transfer material (e.g., a recording paper) via an intermediate transfer member or directly. Next, as a fixing process, the electrophotographic image forming apparatus applies heat and pressure to the transfer material to fix the transferred toner image on a surface of the transfer material.

The developing process can be realized with charged toner particles that move to predetermined positions when an electrostatic force is applied. For example, a two-component developing method is employable for the developing process. The two-component developing system uses a two-component developer (hereinafter, simply referred to as “developer”) that contains non-magnetic toner particles and magnetic carrier particles that are mixed at a predetermined ratio. When the two-component developing system is employed for the developing device, brush-like brushes of the developer (hereinafter, referred to as “magnetic brushes”) are formed on a developer carrier. The developer carrier conveys the developer while holding magnetic brushes to a developing area (i.e., a developing portion) where the developer carrier is opposed to the photosensitive member. Then, in the developing area, the magnetic brushes are brought into frictional contact with the surface of the photosensitive member. Meanwhile, when a developing bias potential is applied to the developer carrier, toner particles contained in the developer are supplied to an image portion of the photosensitive member where an electrostatic latent image is formed, so that the electrostatic latent image can be developed into a toner image. In general, the developer carrier is a cylindrical rotary developing sleeve, in which a magnetic roller including a plurality of magnetic poles (i.e., a magnetic field generation unit) is disposed. In general, the magnetic roller is disposed fixedly. When the developing sleeve causes a rotational movement relative to the stationary magnetic roller, magnetic brushes are conveyed along the surface of the developing sleeve.

In the above-mentioned image forming apparatus, to obtain satisfactory images for a long term, it is necessary to stabilize the amount of applied toners on the photosensitive member (hereinafter, simply referred to as “applied toner amount”) in the developing process. However, the developer deteriorates if it is used for a long term in a continuous image forming operation. In this case, due to an external additive embedded in the toner, the adhesion between the carrier particles and the toner particles tends to increase and the flying amount of toner particles tends to decrease. Then, if the initial settings are maintained continuously, the amount of toners included in a post-development toner image may decrease and accordingly the image density may decrease.

Therefore, to stabilize the applied toner amount, a general method includes detecting the density of an image or a mixing ratio between the toner particles and the carrier particles contained in developing device and changing image forming conditions according to a detection result so as to control the image density to be a desired value. For example, as discussed in Japanese Patent Application Laid-Open No. 5-289464, an optical density detection unit is usable to detect the image density of a post-development toner image and, if the image density reduces, a developing contrast potential Vcont is changed to increase the image density so as to maintain the image density at a desired level. The developing contrast potential Vcont is a potential difference (=|Vdc−V_{L}|) between a developing DC bias potential Vdc and an exposed portion potential V_{L} on the photosensitive member.

Further, it is conventionally known to measure the toner potential of a post-development toner image on the photosensitive member and change image forming conditions according to a measurement result. For example, the method discussed in Japanese Patent Application Laid-Open No. 2001-222140 includes measuring the toner potential of a post-development toner image on the photosensitive member and adjusting the toner density of a developer or the developing contrast potential Vcont based on a ratio of the potential and Vcont.

Further, as discussed in Japanese Patent Application Laid-Open No. 2-120763, it is conventionally known to adjust the image density to a desired level by controlling a rotational speed ratio (i.e., a peripheral speed ratio) between the photosensitive member and the developing sleeve, instead of changing the image forming conditions as mentioned above.

However, there are some problems to be solved when the above-mentioned conventional methods are used.

For example, if the method discussed in Japanese Patent Application Laid-Open No. 5-289464 is employed, an image defect (which is referred to as “void”) may occur. Next, a “void” generating mechanism is described in detail below with reference to FIGS. 29A to 31.

FIGS. 29A, 29B, and 29C are schematic views illustrating a transition of post-development potential (e.g., at the end of life) in relation to an initial potential of a latent image in the process of using a developing device. In the initial usage state of the developing device, toner particles are used in development by an amount comparable to the developing contrast potential Vcont so as to fill up a potential difference between the developing DC bias potential Vdc and the exposed portion potential V_{L}, as illustrated in FIG. 29A. However, if the usage amount of the developing device increases, the adhesion between the toner particles and the carrier particles increases due to deterioration of the developer. Therefore, the applied toner amount decreases so significantly that filling up the developing contrast potential Vcont becomes difficult, as illustrated in FIG. 29B. Thus, a potential difference between the developing DC bias potential Vdc and an outermost layer potential of the post-development toner image (hereinafter, simply referred to as “Vtoner”), i.e., a differential potential ΔV (=|Vdc−Vtoner|), occurs.

In this case, the method discussed in Japanese Patent Application Laid-Open No. 5-289464 includes controlling the developing contrast potential Vcont to be identical to the applied toner amount in the initial usage state as illustrated in FIG. 29C by adjusting charging potential, exposure intensity, and developing bias values. However, as understood from FIG. 29C, the differential potential ΔV continuously remains even after the applied toner amount is increased compared to that illustrated in FIG. 29B.

The differential potential ΔV tends to increase with deterioration of the developer because the magnitude of Vcont, which is necessary to increase the applied toner amount, increases according to the deterioration of developer. It is generally known that an image defect referred to as “void” occurs when the above-described differential potential ΔV is present.

FIGS. 30A and 30B are schematic views each illustrating an output image developed in response to an input signal that instructs sequentially forming a halftone image (hereinafter, referred to as “HT image”) and a solid image (hereinafter, referred to as “HD image”) in an image advancing direction. FIG. 30A illustrates an output image in an initial usage state of the developing device. FIG. 30B illustrates an output image in a state where the usage amount of the developing device increases.

The image defect “void” is a phenomenon that the image density decreases at a boundary portion between the HT image and the HD image, illustrated in FIG. 30B. The reason why the “void” occurs is described below.

FIG. 31 is a schematic view illustrating a “void” generation mechanism. FIG. 31 illustrates an HD image following immediately after a leading HT image in the advancing direction of the photosensitive member, in a state where the photosensitive member and the developing sleeve move in the same direction at a confronting portion thereof. In this case, an image defect “void” occurs if a ratio of the differential potential ΔV to the developing contrast potential Vcont in the HD image portion is large because of the following reason. Specifically, in a case where the ratio ΔV/Vcont is large, there is a sufficient room for the development of a solid image portion. Therefore, an electric field generating based on a potential difference between the HT image portion and the HD image portion may cause toner particles to be supplied to the HT image portion to erroneously adhere to the HD image portion. The toner density decreases at a boundary region of the HT image portion (i.e., a halftone image portion) adjacent to the HD image portion (i.e., the solid image portion). This is the reason why the image defect “void” occurs.

Therefore, reducing the ratio ΔV/Vcont in the HD image portion is required to eliminate the image defect “void.”

On the other hand, according to the method discussed in Japanese Patent Application Laid-Open No. 5-289464, as described with reference to FIGS. 29A to 29C, when the usage amount of the developing device increases (i.e., when the number of image formed sheets increases), the image defect “void” remains and the image quality is not stabilized because the ratio ΔV/Vcont in the HD image portion is large even when the image density remains stable. Further, according to the method discussed in Japanese Patent Application Laid-Open No. 5-289464, an optical density measuring unit is provided to detect the quantity of light reflected from a post-development toner image and the detected quantity of reflected light is converted into an estimated value of the toner density. Therefore, although it is feasible to detect a variation in the toner density, it is difficult to detect a “void” level or the ratio ΔV/Vcont that determines the void level.

On the other hand, according to the method discussed in Japanese Patent Application Laid-Open No. 2001-222140, a potential sensor is used to detect the surface potential of the post-development toner image. The differential potential ΔV (=|Vdc−Vtoner|) can be calculated by using the potential sensor. However, according to the method discussed in Japanese Patent Application Laid-Open No. 2001-222140, a target to be controlled is the toner density in a developing container or the developing contrast potential Vcont. Therefore, similar to the method discussed in Japanese Patent Application Laid-Open No. 5-289464, it is substantially difficult to decrease the differential potential ΔV. The image defect “void” may remain and the image quality may not be stabilized.

Accordingly, it is required to reduce the ratio ΔV/Vcont according to the void level if the differential potential ΔV increases with deteriorating developer.

In this respect, the method discussed in Japanese Patent Application Laid-Open No. 2-120763 decreases the ratio ΔV/Vcont by increasing the rotational speed of the developing sleeve to convey a greater amount of toner to the developing portion so as to increase the applied toner amount. However, if the rotational speed of the developing sleeve increases, a developer conveyance speed increases correspondingly. Therefore, there will be a significant increase in the number of times the developer passes by a regulating blade that regulates the amount of the developer on the developing sleeve. The developer tends to deteriorate faster when it is frequently compressed by the regulating blade. Therefore, the method discussed in Japanese Patent Application Laid-Open No. 2-120763 is not desired to solve the above-mentioned problem (namely the increase in the differential potential ΔV due to the deterioration of developer). The deterioration of the developer may further accelerate.

Accordingly, the present invention is directed to an image forming apparatus that can effectively suppress the generation of a void image while preventing a developer from deteriorating.

### SUMMARY OF THE INVENTION

According to an aspect of the present invention, an image forming apparatus includes an image carrier on which an electrostatic image can be formed, a rotatable developer carrier that can carry and convey a developer containing toner particles and carrier particles to supply the toner particles to the image carrier at a developing area to develop the electrostatic image formed thereon, and a magnetic field generation member that is fixedly disposed in a hollow part of the developer carrier and includes a plurality of magnetic poles disposed in a circumferential direction of the developer carrier. The image forming apparatus further includes a conductive member disposed so as to oppose a predetermined magnetic pole, of the plurality of magnetic poles, which is located odd-number pole upstream of a magnetic pole corresponding to the developing area in a rotational direction of the developer carrier. The image forming apparatus further includes a power source that can apply a voltage to the conductive member, a potential detecting device configured to detect a potential on the image carrier, and a control unit configured to control the voltage to be applied from the power source to the conductive member based on pre-development and post-development potential information about a predetermined latent image pattern formed on the image carrier.

Further features of the present invention will become apparent from the following description of exemplary embodiments with reference to the attached drawings.

### BRIEF DESCRIPTION OF THE DRAWINGS

FIG. 1 is a cross-sectional view illustrating a schematic configuration of an essential part of an image forming apparatus according to an exemplary embodiment of the present invention.

FIG. 2 is a cross-sectional view illustrating a schematic configuration of a developing device according to an exemplary embodiment of the present invention.

FIG. 3 is a flowchart illustrating a voltage changing control for a conductive member according to an exemplary embodiment of the present invention.

FIG. 4 is a flowchart illustrating another voltage changing control for the conductive member according to an exemplary embodiment of the present invention.

FIGS. 5A and 5B illustrate a relationship between latent image potential and developed image potential.

FIG. 6 is a graph illustrating a relationship between a voltage applied to the conductive member and an applied toner amount.

FIG. 7 is a graph illustrating a relationship between voltage applied to the conductive member and ratio ΔV/Vcont.

FIG. 8 is a schematic view illustrating the behavior of developer particles on a developing sleeve according to an exemplary embodiment of the present invention.

FIG. 9 illustrates the result of a simulation analysis with respect to space potential distribution between a photosensitive member and a developing sleeve.

FIG. 10 is a cross-sectional view illustrating a schematic configuration of a developing device that includes another conductive member.

FIG. 11 is a cross-sectional view illustrating a schematic configuration of a developing device that includes another conductive member.

FIG. 12 is a cross-sectional view illustrating a schematic configuration of a developing device that includes another conductive member.

FIG. 13 is a cross-sectional view illustrating a schematic configuration of an essential part of an image forming apparatus according to another exemplary embodiment of the present invention.

FIG. 14 is a flowchart illustrating a voltage changing control for the conductive member according to another exemplary embodiment of the present invention.

FIG. 15 is a flowchart illustrating another voltage changing control for the conductive member according to another exemplary embodiment of the present invention.

FIG. 16 is a graph illustrating a method for calculating a void area based on a difference between an initial value and a test image detection result.

FIG. 17 is a cross-sectional view illustrating a schematic configuration of an essential part of an image forming apparatus according to another exemplary embodiment the present invention.

FIG. 18 is a flowchart illustrating a voltage changing control for the conductive member according to another exemplary embodiment of the present invention.

FIG. 19 is a graph illustrating a relationship between ratio T/D and inductance sensor output value.

FIG. 20 is a graph illustrating a relationship between number of image outputting sheets and ratio T/D.

FIG. 21 is a graph illustrating a transition of the gradient of ratio T/D in relation to the number of image outputting sheets.

FIG. 22 is a graph illustrating a relationship between number of image outputting sheets and voltage applied to the conductive member.

FIG. 23 is a cross-sectional view illustrating a schematic configuration of an essential part of an image forming apparatus according to another exemplary embodiment of the present invention.

FIG. 24 is a flowchart illustrating a voltage changing control for the conductive member according to another exemplary embodiment of the present invention.

FIG. 25 is a graph illustrating a relationship between ratio T/D and image sensor output value.

FIG. 26 is a cross-sectional view illustrating a schematic configuration of an essential part of an image forming apparatus according to another exemplary embodiment of the present invention.

FIG. 27 is a schematic view illustrating a display screen of an operation unit according to another exemplary embodiment of the present invention.

FIG. 28 is a graph illustrating a relationship between operation unit index stage and voltage applied to the conductive member.

FIGS. 29A, 29B, and 29C illustrate a conventional problem.

FIGS. 30A and 30B schematically illustrate generation of a void.

FIG. 31 illustrates a void generation mechanism.

### DESCRIPTION OF THE EMBODIMENTS

Hereinafter, an image forming apparatus according to an exemplary embodiment of the present invention is described in detail below with reference to attached drawings.

### 1. Configuration and Operation of Image Forming Apparatus

FIG. 1 is a cross-sectional view illustrating a schematic configuration of an essential part of an image forming apparatus 100 according to an exemplary embodiment of the present invention.

The image forming apparatus 100 includes a cylindrical (i.e., a drum type) electrophotographic photosensitive member (i.e., a photosensitive member) 1 that is functionally operable as an image carrier. The photosensitive member 1 rotates in a direction indicated by an arrow R1 in FIG. 1, when it is driven. The following functional units are sequentially disposed around the photosensitive member 1 along its rotational direction. First, a charging device 2 is disposed at a predetermined position around the photosensitive member 1. The charging device 2 is a charging unit configured to perform predetermined charging processing according to the present invention. An exposure device 3 is located next to the charging device 2. The exposure device 3 is an exposure unit configured to perform predetermined exposure processing according to the present invention. A developing device 4 is located next to the exposure device 3. The developing device 4 is a developing unit configured to perform predetermined developing processing according to the present invention. An intermediate transfer unit 5 is located next to the developing device 4. The intermediate transfer unit 5 is a transfer device configured to perform predetermined transfer processing according to the present invention. A photosensitive member cleaner 6 is located next to the intermediate transfer unit 5. The photosensitive member cleaner 6 is a photosensitive member cleaning unit configured to perform predetermined cleaning processing according to the present invention.

The intermediate transfer unit 5 includes an intermediate transfer belt 51 that is an endless belt operable as an intermediate transfer member. The intermediate transfer belt 51 is stretched around a drive roller 52, a secondary transfer counter roller 53, and a driven roller 54. When a rotary driving force is transmitted to the drive roller 52, the intermediate transfer belt 51 rotates (moves circularly) in a direction indicated by an arrow R2 at a peripheral speed substantially identical to that of the photosensitive member 1. A primary transfer roller 55, which is a roller-shaped primary transfer member, is disposed so as to be opposed to the photosensitive member 1 on the inner surface side of the intermediate transfer belt 51. The primary transfer roller 55 is a primary transfer unit configured to perform a predetermined primary transfer operation according to the present invention. The primary transfer roller 55 is pressed against the photosensitive member 1 via the intermediate transfer belt 51. A primary transfer portion (i.e., a primary transfer nip) T1, where the intermediate transfer belt 51 and the photosensitive member 1 are brought into contact with each other, is formed. A secondary transfer roller 56, which is a roller-shaped secondary transfer member, is disposed so as to be opposed to the secondary transfer counter roller 53 on the outer surface side of the intermediate transfer belt 51. The secondary transfer roller 56 is a secondary transfer unit configured to perform a predetermined secondary transfer operation according to the present invention. The secondary transfer roller 56 is pressed against the secondary transfer counter roller 53 via the intermediate transfer belt 51. A secondary transfer portion (i.e., a secondary transfer nip) T2, where the intermediate transfer belt 51 and the secondary transfer roller 56 are brought into contact with each other, is formed.

Further, the image forming apparatus 100 includes a transfer material supplying apparatus (not illustrated) that supplies a transfer material P to the secondary transfer portion T2 and a fixing apparatus 10 that fixes a toner image on the transfer material P. The fixing apparatus 10 is a fixing unit configured to perform a predetermined fixing operation according to the present invention.

In an image forming operation, the charging device 2 uniformly charges the surface of the rotating photosensitive member 1 at a predetermined potential to have a predetermined polarity (e.g., negative polarity in the present exemplary embodiment). The exposure device 3 performs scanning exposure processing on the charged surface of the photosensitive member 1 based on image information. Thus, an electrostatic latent image (i.e., an electrostatic image) can be formed on the surface of the photosensitive member 1 according to an exposure image pattern. The developing device 4 develops the electrostatic latent image formed on the photosensitive member 1 into a toner image at a developing area (i.e., a developing portion) D where a developing sleeve 41 of the developing device 4 is opposed to the photosensitive member 1, as described below. The developing device 4 forms magnetic brushes on the developing sleeve 41 with a developer, and conveys the magnetic brushes to the developing area D. Then, at the developing area D, the developing device 4 applies a developing bias to the developing sleeve 41 in a state where the magnetic brushes are brought into contact with the surface of the photosensitive member 1. In this state, toner particles contained in the developer can be supplied to an image portion of the photosensitive member 1 where the electrostatic latent image is formed, so as to develop the electrostatic latent image. Alternatively, the developing device 4 can be configured to transfer the toner particles from the magnetic brushes of the developer to the electrostatic latent image in a state where the magnetic brushes are positioned closely to the photosensitive member 1 without causing the magnetic brushes to directly contact the photosensitive member 1. Further, in the present exemplary embodiment, the developing device 4 develops the electrostatic latent image on the image carrier according to a reversal developing method. More specifically, the developing device 4 develops the toner image from the electrostatic latent image by causing toner particles, which are charged to have the polarity (e.g., negative polarity in the present exemplary embodiment) similar to the charging polarity of the photosensitive member 1, to adhere to the image portion (i.e., the exposed portion) of the photosensitive member 1 whose potential has been reduced in absolute value through the exposure processing after being uniformly charged. A configuration of the developing device 4 and operations to be performed by the developing device 4 are described in detail below.

The toner image formed on the photosensitive member 1 is primarily transferred, at the primary transfer portion T1, by the action of the primary transfer roller 55, onto the intermediate transfer belt 51 moving at a peripheral speed substantially similar to that of the photosensitive member 1. In this case, a primary transfer power source (not illustrated) applies a predetermined primary transfer bias potential to the primary transfer roller 55. The primary transfer bias potential has a polarity opposite to the regular charging polarity of the toner particles used for the development. The toner image formed on the intermediate transfer belt 51 is secondarily transferred, at the secondary transfer portion T2, by action of the secondary transfer roller 56, onto the transfer material P when the transfer material P is sandwiched between the intermediate transfer belt 51 and the secondary transfer roller 56 while the transfer material P is conveyed. In this case, a secondary transfer power source (not illustrated) applies a predetermined secondary transfer bias potential to the secondary transfer roller 56. The secondary transfer bias potential has a polarity opposite to the charging polarity of the toner particles used for the development. The transfer material supplying apparatus conveys the transfer material P to the secondary transfer portion T2 so as to synchronize the position of the transfer material P with the position of a toner image formed on the intermediate transfer belt 51.

The transfer material P on which the toner image has been transferred is then separated from the intermediate transfer belt 51 and conveyed to the fixing apparatus 10. The fixing apparatus 10 includes a heating roller 11 and a pressing roller 12 that can heat and press the transfer material P in a state where the transfer material P is nipped between these rollers 11 and 12, while the transfer material P is conveyed in the fixing apparatus 10, so that the toner image can be fixed as an adhesion image. The transfer material P on which the toner image has been fixed is subsequently output, as a final image product, from the exit of the image forming apparatus 100.

Meanwhile, some of toner particles may remain on the photosensitive member 1 without being transferred onto the intermediate transfer belt 51 when the primary transfer processing has been completed. The photosensitive member cleaner 6 removes the toner particles remaining on the photosensitive member 1 and collects them as primary transfer toner residue. Thus, the photosensitive member 1 can be repetitively used, as long as it is cleaned sufficiently, for the next and subsequent image forming operations. Further, some of toner particles may remain on the intermediate transfer belt 51 without being transferred onto the transfer material P when the secondary transfer processing has been completed. An intermediate transfer member cleaning unit (not illustrated) removes the toner particles remaining on the intermediate transfer belt 51 and collects them as the secondary transfer toner residue. Thus, the intermediate transfer belt 51 can be repetitively used, as long as it is cleaned sufficiently, for the next and subsequent image forming operations.

As an example, the image forming apparatus 100 can be configured to include a plurality of image forming units, each including the photosensitive member 1, the charging device 2, the exposure device 3, the developing device 4, the primary transfer roller 55, and the photosensitive member cleaner 6, as mentioned above, to form a color image. For example, yellow (Y), magenta (M), cyan (C), and black (K) image forming units can be disposed sequentially in the moving direction of the intermediate transfer belt 51, so as to face the surface of the intermediate transfer belt 51 on which the image is transferred. For example, in a case where the image forming apparatus 100 forms a full-color image, each color toner image formed on each photosensitive member 1 of each image forming unit is primarily transferred onto the intermediate transfer belt 51 at each primary transfer portion T1 in such a manner that respective toner images are overlapped with each other on the intermediate transfer belt 51. Subsequently, the toner images overlapped so as to form a color image are secondarily transferred together from the intermediate transfer belt 51 to the transfer material P at the secondary transfer portion T2.

In the present exemplary embodiment, the photosensitive member 1 is an a-Si photosensitive cylindrical rotary member that includes an a-Si photosensitive layer formed on a conductive base body. The photosensitive member 1 rotates in the direction indicated by the arrow R1 at a predetermined speed (i.e., a peripheral speed) when it is driven by a drive motor (not illustrated), which serves as a drive unit. Further, in the present exemplary embodiment, the charging device 2 charges the photosensitive member 1 to have a potential of −480V.

In the present exemplary embodiment, the charging device 2 is a magnetic brush type. The magnetic brush type charging apparatus includes a cylindrical rotary charging sleeve and a magnetic roller disposed in the charging sleeve. The charging sleeve is brought into contact with the surface of the photosensitive member 1 while conveying brushes of magnetic particles formed on the surface (magnetic charging brush). Subsequently, when a predetermined charging bias is applied to the charging sleeve, the surface of the photosensitive member 1 is charged typically according to an injection charging method. Using a magnetic brush type charging device is useful to reduce image deletion and micro charging unevenness that may be caused by the electric discharge products.

The exposure device 3 is, for example, an analog exposure apparatus that projects a document image or a digital exposure apparatus, such as a laser scanner or a light-emitting diode (LED) array. The exposure device 3 employed in the present exemplary embodiment is a laser scanner (i.e., one of the digital exposure apparatuses).

### 2. Control Aspect

The image forming apparatus 100 includes a control unit 110 that can control various operations to be performed by the image forming apparatus 100. The control unit 110 includes a central processing unit (CPU) 111 that is functionally operable as a control unit configured to perform predetermined processing according to the present invention. The control unit 110 includes a read only memory (ROM) 112 and a random access memory (RAM) 113 that are functionally operable as a storage unit configured to store predetermined information and data according to the present invention. In the control unit 110, the CPU 111 controls operations to be performed by various units of the image forming apparatus 100 according to a program and data loaded into the RAM 113 from the ROM 112.

The control unit 110 is configured to control an image forming operation for causing the image forming apparatus 100 to output an image based on input image information. In particular, as one of features relevant to the present exemplary embodiment, the control unit 110 is configured to control an operation for changing a voltage Vp applied to a conductive member 7 as described below. More specifically, in the present exemplary embodiment, as described in detail below, the CPU 111 is functionally operable as a changing unit configured to change the voltage applied to the conductive member 7 from a toner urging power source 9.

### 3. Developing Apparatus

Next, a configuration of the developing device 4 according to the present exemplary embodiment is described in detail below. FIG. 2 is a cross-sectional view illustrating a schematic configuration of the developing device 4 according to the present exemplary embodiment.

The developing device 4 includes the cylindrical rotary developing sleeve 41 and a magnetic roller 42. The developing sleeve 41 is operable as a developer carrier that can carry and convey the developer. The magnetic roller 42 is fixedly disposed in a hollow part of the developing sleeve 41. The magnetic roller 42 is constituted by a columnar permanent magnet and operable as a magnetic field generation unit. The developing sleeve 41 and the magnetic roller 42 cooperatively constitute a developing member 43 that supplies the developer to the developing area D. The developing sleeve 41 is disposed in a confronting relationship with the photosensitive member 1 so as to maintain a predetermined clearance (i.e., a predetermined air gap) between them. Further, in the present exemplary embodiment, a nearest-neighbor distance between the developing sleeve 41 and the photosensitive member 1 is set to be 300 μm.

The longitudinal direction (i.e., the rotational axis direction) of the developing sleeve 41 is substantially parallel to the longitudinal direction (i.e., the rotational axis direction) of the photosensitive member 1. Further, the magnetic roller 42 and the developing sleeve 41 are disposed substantially coaxially so that a predetermined clearance (air gap) can be maintained between the magnetic roller 42 and an inner cylindrical surface of the developing sleeve 41. The magnetic roller 42 extends substantially from one end to the other end of the developing sleeve 41 in the longitudinal direction (i.e., the rotational axis direction) of the developing sleeve 41.

Further, the developing device 4 includes a developer container 46 that accommodates a two-component developer including toner particles and carriers. The developer container 46 includes an opening 46a, which is opposed to the photosensitive member 1. The developing sleeve 41 partly protrudes from the opening 46a in a state where the developing sleeve 41 is positioned regularly. In the present exemplary embodiment, the developing sleeve 41 is rotatable about its rotational shaft and is supported by the developer container 46. On the other hand, the magnetic roller 42 is fixed to the developer container 46. Further, a screw 45 is disposed in the developer container 46. The screw 45 is operable as a stir-conveyance member that can stir the developer and convey the developer to the developing sleeve 41.

Further, a regulating blade 44 is disposed on the upstream side of the opening 46a in the rotational direction of the developing sleeve 41 (i.e., a direction indicated by an arrow R3 in the drawing). The regulating blade 44 is operable as a developer regulating member positioned at a peripheral edge portion of the developer container 46. The regulating blade 44 is disposed adjacently and opposed to the developing sleeve 41 so as to maintain a predetermined clearance (air gap) between them. Further, the regulating blade 44 extends substantially from one end to the other end of the developing sleeve 41 in the longitudinal direction (i.e., the rotational axis direction) of the developing sleeve 41.

Further, the conductive member 7 is disposed on the downstream side of the regulating blade 44, and on the upstream side of the developing area D, in the rotational direction of the developing sleeve 41 (i.e., in the direction indicated by the arrow R3 in the drawing). The conductive member 7 is disposed in a confronting relationship with the developing sleeve 41 so as to maintain a predetermined clearance (i.e., a predetermined air gap) between them. Further, the conductive member 7 extends substantially from one end to the other end of the developing sleeve 41 in the longitudinal direction (i.e., the rotational axis direction).

The developing sleeve 41 is connected to a developing power source (i.e., oscillating device) 8, which is operable as a developing bias applying unit configured to apply a developing bias potential (i.e., a developing voltage) thereto. The developing power source 8 includes a waveform signal oscillator 81 and a high-voltage power source 82. The high-voltage power source 82 amplifies a signal generated from the waveform signal oscillator 81 and applies the developing bias potential to the developing sleeve 41.

More specifically, the developing bias potential applied by the developing power source 8 is an oscillating voltage that contains a rectangular wave of 6 kHz frequency and 1.5 kV peak-to-peak voltage superposed on −330V developing DC bias potential Vdc (Vcont=200V). It is desired that the peak-to-peak voltage in an AC component of the developing bias potential is in a range from 0.7 kV to 1.8 kV. If the peak-to-peak voltage in the AC component of the developing bias potential is greater than 1.8 kV, electric discharge traces tend to occur. The electric discharge traces are scars on the photosensitive member 1 that may occur when the peak-to-peak voltage is large in a state where a strong electric field is generated in the developing area, because electric discharge is induced by a low-resistance material existing in the developing device 4 and electric breakdown occurs partly at a layer of the photosensitive member 1. The above-mentioned low-resistance material is, for example, chips of the developing sleeve 41. On the other hand, if the peak-to-peak voltage in the AC component of the developing bias potential is less than 0.7 kV, the image uniformity tends to decrease steeply because relocation of toner particles on the photosensitive member 1 does not occur easily. Further, it is desired that the frequency of the AC component of the developing bias potential is in a range from 4 kHz to 12 kHz. If the frequency of the AC component of the developing bias potential is greater than 12 kHz, the behavior of the toner particles cannot follow a change in the polarity of the developing bias potential. The character reproducibility and the image uniformity decrease significantly. On the other hand, if the frequency of the AC component of the developing bias potential is less than 4 kHz, the image uniformity tends to decrease steeply because the number of times with respect to the relocation of toner particles decreases in the developing area. The waveform of the developing bias potential is not limited to the rectangular waveform and can be, for example, a sine waveform or any other waveform.

In the present exemplary embodiment, the developing sleeve 41 rotates in the direction indicated by the arrow R3 when it is driven. More specifically, in the developing area D, the moving direction of the surface of the developing sleeve 41 is identical to the moving direction of the surface of the photosensitive member 1. However, the present exemplary embodiment is not limited thereto. For example, the developing sleeve 41 and the photosensitive member 1 may be configured to rotate in such a manner that the surface of the developing sleeve 41 and the surface of the photosensitive member 1 move in opposite directions in the developing area D.

The developing area D is an area that can contribute to the development of an electrostatic latent image in each moving direction of respective surfaces of the photosensitive member 1 and the developing sleeve 41. More specifically, the developing area D is an area in which toner particles can be transferred from the developing sleeve 41 to the photosensitive member 1 if a developing operation is performed in a state where the developing sleeve 41 and the photosensitive member 1 are not rotated.

In the present exemplary embodiment, the magnetic roller 42 includes a plurality of magnetic poles S1, N2, S2, N3, and N1 disposed in the circumferential direction thereof. These magnetic poles S1, N2, S2, N3, and N1 are disposed in this order in a direction opposite to the rotational direction of the developing sleeve 41 (i.e., a direction opposite to the developer passing direction in the developing area D).

As to the magnetic pole name, “S” represents an S-pole of a magnet and “N” represents an N-pole of a magnet. Further, to facilitate understanding, positions of the developing sleeve 41 corresponding to the magnetic poles of the magnetic roller 42 are simply referred to as magnetic pole positions on the developing sleeve 41.

In the present exemplary embodiment, the magnetic pole S1 is a developing pole (or a developing principal pole) that corresponds to the developing area D in the circumferential direction of the developing sleeve 41. More specifically, the magnetic pole corresponding to (or existing in) the developing area D is one of a plurality of magnetic poles of the magnetic roller 42 that can generate a magnetic force to hold brushes of a developer (i.e., magnetic brushes) to be used in the development in the developing area D on the developing sleeve 41. The magnetic pole corresponding to the developing area D is closest to the photosensitive member 1 in the circumferential direction of the developing sleeve 41. In other words, the magnetic pole corresponding to the developing area D is a magnetic pole that can form developer brushes positioned nearest to or directly contacting the photosensitive member 1 on the developing sleeve 41. In the present exemplary embodiment, the developer brushes formed by the developing pole S1 and positioned on the developing sleeve 41 contact the photosensitive member 1 in the developing area D. In the state where the magnetic pole holds or forms the developer brushes on the developing sleeve 41, the magnetic pole neighbors the end portion (i.e., the proximal end portion) of developer brushes on the developing sleeve 41.

The magnetic pole N2 is positioned next to the developing pole S1 on the upstream side of the magnetic pole S1 in the rotational direction of the developing sleeve 41. The magnetic pole N2 serves as a toner urging pole. More specifically, the toner urging pole N2 is an upstream-side magnetic pole preceding the developing pole S1 in the rotational direction of the developing sleeve 41.

In the present exemplary embodiment, the conductive member 7 is disposed so as to oppose the toner urging pole N2 and contact the magnetic brushes on the developing sleeve 41.

In the present exemplary embodiment, the conductive member 7 has an arc-shaped surface that is opposed to an outer cylindrical surface of the developing sleeve 41 (entirely in the present exemplary embodiment) and coaxial with the developing sleeve 41, when seen along the longitudinal direction (i.e., the rotational axis direction) of the developing sleeve 41. More specifically, in the present exemplary embodiment, at least at the surface opposing the outer cylindrical surface of the developing sleeve 41, the conductive member 7 has a curvature substantially identical to that of the outer cylindrical surface of the developing sleeve 41. Further, the conductive member 7 is disposed so as to keep a 600 μm distance (nearest-neighbor distance) L between the opposing surface of the conductive member 7 and the outer cylindrical surface of the developing sleeve 41.

In the present exemplary embodiment, the conductive member 7 is located so as to be opposed to the toner urging pole N2, which is located immediately upstream of the developing pole S1 (corresponding to the developing area D) in the rotational direction of the developing sleeve 41. However, the location of the conductive member 7 is not limited to the above-mentioned example. The conductive member 7 can be located so as to be opposed to a predetermined magnetic pole, which is located odd-number pole upstream of the developing pole S1 (corresponding to the developing area D) in the rotational direction of the developing sleeve 41, as described below.

The conductive member 7 is connected to the toner urging power source (e.g., an oscillating apparatus) 9, which is operable as a toner urging bias applying unit configured to apply a below-described toner urging bias potential (i.e., a toner urging voltage), which is hereinafter simply referred to as “Vp.” The toner urging power source 9 includes a waveform signal oscillator 91 and a high-pressure power source 92. The high-pressure power source 92 can amplify a signal generated by the waveform signal oscillator 91 and apply the toner urging bias potential to the conductive member 7.

More specifically, in the present exemplary embodiment, the toner urging bias potential is a DC voltage. However, the present invention is not limited to the above-mentioned example. The toner urging bias potential is described in detail below.

Further, in the present exemplary embodiment, the magnetic pole S2 is located immediately upstream of the toner urging pole N2 in the rotational direction of the developing sleeve 41. The magnetic pole S2 serves as a regulating pole. More specifically, the regulating pole S2 is an upstream-side magnetic pole positioned next but one to the developing pole S1 in the rotational direction of the developing sleeve 41. In the present exemplary embodiment, the regulating blade 44 is disposed so as to oppose the regulating pole S2 and contact the magnetic brushes on the developing sleeve 41. The regulating blade 44 can regulate a layer thickness of the developer on the developing sleeve 41 in a state where a magnetic force is generated by the magnetic pole S2.

In the state where the regulating blade 44 opposes a magnetic pole, the regulating blade 44 is positioned on a straight line extending in the radial direction of the magnetic roller 42 and passing through a peak position of the magnetic flux density in a normal direction of the magnetic pole. However, it is allowable that the regulating blade 44 may slightly offset from the straight line to the upstream side or the downstream side in the rotational direction of the developing sleeve 41. In short, it is desired that the regulating blade 44 is located on a straight line extending in the radial direction of the magnetic roller 42 and passing through the distal end (i.e., the radial outer end) of the magnetic brushes standing on the developing sleeve 41 completely or mostly under the magnetic force generated by the magnetic pole. Typically, it is desired that the regulating blade 44 is positioned closely to the straight line extending in the radial direction of the magnetic roller 42 and passing through the peak position of the magnetic flux density in the normal direction of the magnetic pole within a range of ±30° in the circumferential direction of the magnetic roller 42.

Further, in the present exemplary embodiment, the magnetic pole N3 is located immediately upstream of the regulating pole S2 in the rotational direction of the developing sleeve 41. Further, the magnetic pole N1 is located immediately upstream of the magnetic pole N3. At the position of the magnetic pole N3, the developer particles adhere to the developing sleeve 41. Two magnetic poles N3 and N1 are neighboring repellent magnetic poles. When the developer particles adhering to the developing sleeve 41 are positioned between these magnetic poles N3 and N1, the developer particles are removed off the developing sleeve 41 and mixed with residual developer particles in the developer container 46.

Further, in the present exemplary embodiment, the image forming apparatus 100 includes a post-development potential sensor 121 and a pre-development potential sensor 122, each being operable as a surface potential meter, as illustrated in FIG. 1. More specifically, each of the potential sensors 121 and 122 is operable as a void detection unit configured to detect the void level of a toner image having been subjected to the developing process. In the present exemplary embodiment, the post-development potential sensor 121 is attached to a lower part of the developing device 4 so that the post-development potential sensor 121 can measure the surface potential of the photosensitive member 1 where a toner image is formed, on the downstream side of the developing area D in the moving direction of the surface of the photosensitive member 1. In the present exemplary embodiment, the pre-development potential sensor 122 is attached to an upper part of the developing device 4 so that the pre-development potential sensor 122 can measure the surface potential of the photosensitive member 1, on the upstream side of the developing area D in the moving direction of the surface of the photosensitive member 1.

The post-development potential sensor 121 and the pre-development potential sensor 122 are capable of detecting the ratio ΔV/Vcont that substantially determines the void level.

The post-development potential sensor 121 and the pre-development potential sensor 122 are usable in a control to change the voltage applied to the conductive member Vp as described below.

The layout of the magnetic poles of the magnetic roller 42 is not limited to the example illustrated in FIG. 2. The magnetic poles of the magnetic roller 42 can be differently arranged if they satisfy the below-described requirements of the present invention.

### 4. Vp Changing Control

Next, The voltage Vp changing control according to the present exemplary embodiment is described in detail bellow with reference to a flowchart illustrated in FIG. 3.

In the present exemplary embodiment, in step S101, the CPU 111 starts the voltage Vp changing control if use history information about the developing device 4 indicates that the number of image formed sheets exceeds a predetermined value in an ordinary image formation standby state. However, the use history information about the developing device 4 is not limited to the number of image formed sheets. The use history information about the developing device 4 may be driving time of the developing device 4 (e.g., rotating time of the developing sleeve) or driving amount of the developing device 4 (e.g., rotational speed of the developing sleeve). More specifically, any information indicating the usage amount of the developer is employable.

First, in step S102, the CPU 111 causes the image forming apparatus 100 to form a predetermined image pattern (hereinafter, referred to as “differential potential measurement image”) as a test image on the photosensitive member 1. In the present exemplary embodiment, the image pattern is a solid image (i.e., an image of maximum density level). The image pattern can be formed to have an arbitrary size suitable for the detection using the below-described potential sensor, within an image formable range in the longitudinal direction (i.e., the rotational axis direction) of the photosensitive member 1. Setting values stored beforehand in the ROM 112 of the control unit 110 are usable as image forming conditions including the developing DC bias potential Vdc.

Next, in step S103, the CPU 111 causes the pre-development potential sensor 122 to measure an exposed portion potential (V_{L}) on the pre-development photosensitive member 1, about the differential potential measurement image, and causes the post-development potential sensor 121 to measure a surface potential (Vtoner) of the post-development toner image.

Next, in step S104, the CPU 111 calculates a ratio ΔV/Vcont of the differential potential ΔV to the developing contrast potential Vcont. More specifically, the CPU 111 calculates the ratio ΔV/Vcont according to the following formula (1), using the exposed portion potential (V_{L}) about the differential potential measurement image in the pre-development state and the surface potential (Vtoner) of the post-development toner image, which have been measured in step S103, and the developing DC bias potential Vdc stored beforehand in the ROM 112.

ΔV/Vcont=(|Vdc−Vtoner|)/(|Vdc−V_{L}|) (1)

Next, in step S105, the CPU 111 determines whether the ratio ΔV/Vcont calculated based on the above-mentioned formula (1) is greater than 0.1.

If it is determined that the ratio ΔV/Vcont is equal to or less than 0.1 (NO in step S105), then in step S107, the CPU 111 determines to use the previous setting values and terminates the processing of the flowchart illustrated in FIG. 3 without changing the voltage Vp to be applied to the conductive member 7.

On the other hand, if it is determined that the ratio ΔV/Vcont is greater than 0.1 (“YES” in step S105), then in step S106, the CPU 111 changes the voltage Vp to a desired value with reference to a below-described table (see FIG. 7). Subsequently, in step S107, the CPU 111 terminates the processing of the flowchart illustrated in FIG. 3.

As another method, the processing flow can be modified as illustrated in FIG. 4 to cause the CPU 111 to perform the processing in step S102 again after changing the voltage Vp in step S106 and repetitively perform the processes of calculating the ratio ΔV/Vcont and changing the voltage Vp until it is determined that the ratio ΔV/Vcont is equal to or less than 0.1. In this case, in step S106, the CPU 111 can change the voltage Vp by a predetermined change width having been set beforehand (typically, the voltage Vp is increased toward the toner charging polarity side in the developing operation). Thus, the CPU 111 can accurately set the voltage Vp to a desired value. In the flowchart illustrated in FIG. 4, processing identical or similar to that described in the flowchart illustrated in FIG. 3 is denoted by the same step number. Further, it is desired to perform conventional image density control in addition to the above-mentioned control of the ratio ΔV/Vcont. More specifically, the CPU 111 forms a predetermined image pattern (step S102 in FIG. 4) after changing the voltage Vp to a desired value (step S106 illustrated in FIG. 4). Then, the CPU 111 measures the image density using a conventional image density detection method in addition to the measurement of the ratio ΔV/Vcont. The conventional image density detection method is, for example, patch detection type ATR using an optical fiber patch sensor. The patch detection type ATR is characterized by causing the optical fiber patch sensor to detect the density of a patch image (i.e., a toner image of a predetermined image pattern) formed on a carrier, such as the photosensitive member or the intermediate transfer belt. Through the above-mentioned measurement, if it is determined that the ratio ΔV/Vcont is equal to or less than 0.1 and the image density is within a desired range, the CPU 111 terminates the processing of the flowchart without further changing the settings. On the other hand, if it is determined that the image density is outside the desired range although the ratio ΔV/Vcont is equal to or less than 0.1, the CPU 111 adjusts the voltage Vp within a range in which the ratio ΔV/Vcont does not exceed 0.1 and controls the image density. In this case, a conventional image density controlling method is employable to control the image density. For example, the conventional image density controlling method includes adjusting the developer toner density through toner replenishment or discharge and adjusting the image density by changing the toner charging amount (tribo). The developer toner density is a ratio of the weight of toner particles to the entire weight of the developer including toner particles and carrier particles (hereinafter, referred to as “ratio T/D”).

Further, it is useful to employ another method that includes changing the photosensitive member or developing bias potential settings to adjust the developing contrast potential Vcont so as to adjust the image density.

Next, the reason why the threshold value of the ratio ΔV/Vcont is set to 0.1 in the present exemplary embodiment is described in detail bellow.

To obtain the threshold value, the image forming apparatus generates a plurality of “void” evaluation images each including the HD image portion (i.e., the solid image portion) following immediately after the HT image portion (i.e., the halftone image portion), which has been described with reference to FIGS. 30A and 30B, while setting only the developing contrast potential Vcont to be variable. The developer used in the evaluation includes an unused developer (i.e., an initial agent) and a developer used in continuous image forming operations (1 k sheets) (i.e., an endured agent). Table 1 is visual evaluation results about the phenomenon “void” in respective images output in relation to calculated ratio ΔV/Vcont.

TABLE 1
Void Evaluation

Vcont

| | 150 | 200 | 250 | 300 |
|---|---|---|---|---|
| Initial agent ΔV/Vcont | 0.00 | 0.00 | 0.05 | 0.05 |
| Initial agent void | ∘ | ∘ | ∘ | ∘ |
| Endured agent ΔV/Vcont | 0.10 | 0.15 | 0.20 | 0.25 |
| Endured agent void | ∘ | x | x | x |

In the visual evaluation, “o” indicates permissible level and “x” indicates defective level. As illustrated in the table 1, it can be confirmed that the “void” is defective when the ratio ΔV/Vcont is greater than 0.1 and permissible when the ratio ΔV/Vcont is equal to or less than 0.1. This is the reason why the threshold value of the ratio ΔV/Vcont is set to 0.1.

The permissible level of the “void” is variable depending on an actual configuration (e.g., product spec) of the image forming apparatus. Therefore, the threshold value of the ratio ΔV/Vcont is not limited to 0.1.

The control terminates after the above-mentioned processing. The image forming apparatus performs ordinary image forming operations using the changed voltage Vp. When the differential potential ΔV increases with deteriorating developer, the ratio ΔV/Vcont can be reduced and the defectiveness of the void can be suppressed by repetitively performing the above-mentioned operation. Accordingly, it is feasible to assure stable image quality in a long-term usage of the image forming apparatus without being adversely influenced by the “void.” A detailed “void” suppressing mechanism is described in detail below.

### 5. Mechanism

Next, a method for changing the voltage Vp to be applied to the conductive member 7 according to the present exemplary embodiment is described in detail below.

FIG. 5A schematically illustrates the post-development potential with respect to the latent image potential in a case where it is determined that the ratio ΔV/Vcont is equal to or less than 0.1 in step S105 of the control flow illustrated in FIG. 3. On the other hand, FIG. 5B schematically illustrates the same in a case where it is determined that the ratio ΔV/Vcont is greater than 0.1.

FIG. 5B illustrates a state where the differential potential ΔV increases with deteriorating developer. More specifically, as described with reference to FIG. 29B, the differential potential ΔV is generated when the amount of applied toners decreases so significantly that filling up the developing contrast potential Vcont becomes difficult. In this state, a desired amount of applied toners can be obtained by increasing the developing contrast potential Vcont. However, as mentioned above, this method is not useful in that the defectiveness of the “void” cannot be suppressed because the ratio ΔV/Vcont remains large.

Therefore, in the present exemplary embodiment, the image forming apparatus changes the voltage Vp to be applied to the conductive member 7 when the developing state becomes the state illustrated in FIG. 5B. In this case, it is important that the conductive member 7 opposes the toner urging pole N2, which is located odd-number pole upstream of the developing pole S1 (corresponding to the developing area D) in the rotational direction of the developing sleeve 41, and contacts magnetic brushes, as described below. Changing the voltage Vp as mentioned above is effective to increase the amount of applied toners and reduce the ratio ΔV/Vcont.

FIG. 6 illustrates the relationship between the voltage Vp (absolute value) and the applied toner amount of a toner image on the post-development photosensitive member 1, under the condition that the developing contrast potential Vcont is constant. Further, FIG. 7 illustrates the relationship between the calculated ratio ΔV/Vcont and the voltage Vp (absolute value), under the condition that the developing contrast potential Vcont is constant.

The ROM 112 stores the relationship illustrated in FIG. 7 as a table to be required in determining the voltage Vp, so that the table can be referred to in step S106 of the control flow illustrated in FIG. 3. The CPU 111 obtains a desired value of the voltage Vp that is required to set the present ratio ΔV/Vcont to be equal to or less than 0.1 with reference to the table. The CPU 111 determines to apply the obtained voltage Vp to the conductive member 7 in a subsequent image forming operation. For example, the CPU 111 obtains a difference between the present ratio ΔV/Vcont and a reference ratio ΔV/Vcont having been set beforehand. In this case, the reference ratio ΔV/Vcont is equal to or less than 0.1. Further, the CPU 111 obtains a Vp changing amount to be required in changing the ratio ΔV/Vcont by the above-mentioned difference based on the ΔV/Vcont-to-Vp relationship illustrated in FIG. 7 (e.g., information relating to the gradient). Then, the CPU 111 changes the voltage Vp according to the obtained changing amount.

More specifically, the image forming apparatus 100 according to the present exemplary embodiment includes the potential detection units 121 and 122 that can detect a pre-development potential and a post-development potential of a predetermined image formed on the image carrier. Further, in the present exemplary embodiment, the image forming apparatus 100 includes the CPU 111 that is operable as a changing unit configured to change the voltage to be applied from the toner urging power source 9 to the conductive member 7 based on detection results obtained by two potential detection units 121 and 122. More specifically, the CPU 111 (i.e., the changing unit) changes the voltage to be applied from the toner urging power source 9 to the conductive member 7 based on the ratio (ΔV/Vcont) of the differential potential ΔV to the developing contrast potential Vcont. The developing contrast potential Vcont is a potential difference between the DC component potential of the developing voltage applied to the developer carrier and the pre-development potential of the above-mentioned predetermined image detected by the potential detection unit. Further, the differential potential ΔV is a potential difference between the DC component potential of the developing voltage and the post-development potential of the above-mentioned predetermined image detected by the potential detection unit. More specifically, in the present exemplary embodiment, the CPU 111 changes the voltage to be applied from the toner urging power source 9 to the conductive member 7 when the above-mentioned ratio is greater than a predetermined value. Typically, when the above-mentioned ratio becomes larger, the CPU 111 increases the voltage to be applied from the toner urging power source 9 to the conductive member 7 toward the toner charging polarity side in the developing operation with reference to the above-mentioned table.

In FIG. 6, increasing the amount of applied toners is easy when the voltage Vp (absolute value) is greater than the developing DC bias potential Vdc (absolute value), compared to the case where the conductive member 7 is not provided. More specifically, when the DC component potential of the voltage Vp is higher than the developing DC bias potential toward the toner charging polarity side in the developing operation (negative polarity side in the present exemplary embodiment), increasing the amount of applied toners is easy compared to the case where the conductive member 7 is not provided. As a result, the ratio ΔV/Vcont can be reduced as illustrated in FIG. 7.

The reason why the above-mentioned function can be expected is described below with reference to FIG. 8. FIG. 8 illustrates the behavior of developer particles on the developing sleeve 41 in a region extending from the position corresponding to the regulating pole S2 to the position corresponding to the developing pole S1, according to the present exemplary embodiment, as a schematic view developed in the moving direction of the surface of the developing sleeve 41.

A developer containing toner particles t and carrier particles c (i.e., two-component developer) is conveyed into the gap between the developing sleeve 41 and the regulating blade 44 opposing the magnetic pole S2, when the developing sleeve 41 rotates in the direction indicated by the arrow R3. While the developing sleeve 41 further rotates in the arrow R3 direction, the developer on the developing sleeve 41 is regulated by the gap between the developing sleeve 41 and the regulating blade 44 to have a uniform layer thickness. Thus, the developing sleeve 41 can be coated with a desired amount of developer (in a region P101).

Subsequently, while the developing sleeve 41 further rotates in the arrow R3 direction, the developer having the regulated layer thickness on the developing sleeve 41 is conveyed to the gap between the conductive member 7 opposing the magnetic pole N2 and the developing sleeve 41 (in a region P102). In this case, in the present exemplary embodiment, magnetic brushes M stand on the surface of the developing sleeve 41 and contact the conductive member 7 when the magnetic force is generated by the magnetic pole N2.

Thus, in the present exemplary embodiment, at least in an image forming operation, a potential difference is formed between the developing sleeve 41 and the conductive member 7 so as to cause the toner particles t contained in the magnetic brushes M contacting the conductive member 7 on the developing sleeve 41 to move from the conductive member 7 side to the developing sleeve 41 side. More specifically, the toner urging bias potential is applied from the toner urging power source 9 to the conductive member 7 so as to form the above-mentioned potential difference between the conductive member 7 and the developing sleeve 41 to which the developing bias potential is applied from the developing power source 8. More specifically, the voltage Vp having the polarity identical to the toner charging polarity (negative polarity in the present exemplary embodiment) in the developing operation and the absolute value greater than the developing DC bias potential Vdc is applied to the conductive member 7. Therefore, an electric field E1 that causes the toner particles t to move from the conductive member 7 side to the developing sleeve 41 side is formed between the conductive member 7 and the developing sleeve 41. As a result, due to the function of the electric field E1, the toner particles t positioned in the vicinity of the conductive member 7 move toward the vicinity of the developing sleeve 41 (in a region P103).

Subsequently, while the developing sleeve 41 further rotates in the arrow R3 direction, the magnetic brushes M on the developing sleeve 41 are conveyed via the gap between the conductive member 7 and the developing sleeve 41 (in a region P104). Subsequently, each magnetic brush M is turned upside down (rotated 180 degrees) while it approaches the position corresponding to the magnetic pole S1 in a region extending from the magnetic pole N2 to the magnetic pole S1 (see a region P105). More specifically, each magnetic brush M lies down along the magnetic force line of the magnetic pole N2 and then rises up along the magnetic force line of the magnetic pole S1 while the developing sleeve 41 moves in the arrow R3 direction. In this case, each magnetic brush M has a proximal end portion that is located stationarily and closely to the magnetic pole and a distal end that is rotatable to lie down or rise up. Thus, each magnetic brush M causes a rotating motion on the developing sleeve 41 in a direction identical to the rotational direction of the developing sleeve 41. This is the reason why the magnetic brush M is turned upside down in the drawing. The above-mentioned rotating motion of each magnetic brush M is not limited to the exact rotation of the magnetic brush M. If the ratio of the developer (i.e., carrier particles c) moving from the distal end portion to the proximal end portion of the magnetic brush M is relatively greater than that of the developer moving oppositely in the process of moving from the position corresponding to the preceding magnetic pole to the position corresponding to the following magnetic pole, it can be regarded that the magnetic brush M is rotating.

In this case, due to the function of the electric field E1 generated between the conductive member 7 and the developing sleeve 41, the toner particles t contained in a magnetic brush M having moved to the vicinity of the developing sleeve 41 are constrained by the carrier particles c or other magnetic brushes M and are held in this state. Therefore, the toner particles t contained in the magnetic brush M and held in the vicinity of the developing sleeve 41 are then positioned closely to the photosensitive member 1 in accordance with the rotating motion of the magnetic brush M.

Subsequently, the magnetic brush M on the developing sleeve 41 is disposed between the photosensitive member 1 and the developing sleeve 41 in the developing area D when the developing sleeve 41 further rotates in the arrow R3 direction. In this state, the magnetic brush M standing on the surface of the developing sleeve 41 contacts the photosensitive member 1 under the magnetic force of the magnetic pole S1. Then, in the developing area D, the toner particles t contained in the magnetic brush M on the developing sleeve 41 moves from the developing sleeve 41 side to the photosensitive member 1 side (see a region P106), due to the function of the electric field (i.e., development field) E2 generated between the photosensitive member 1 and the developing sleeve 41.

As described above, in the present exemplary embodiment, it is feasible to increase the amount of toners in the vicinity of the photosensitive member 1 and decrease the amount of toners in the vicinity of the developing sleeve 41, in the developing area D. The developer in the above-mentioned state can demonstrate the following two functions synergistically. Therefore, it is believed that a greater amount of toner particles can move to the photosensitive member 1 on condition that Vcont is constant.

(1) In the developing area D, the amount of toners increases in the vicinity of the photosensitive member 1 to which the strong development field can be easily applied.
(2) In the developing area D, the amount of toners decreases in the vicinity of the developing sleeve 41. Therefore, the electric resistance of the developer decreases and the development field can be further enhanced.

The above-mentioned two functions are described in detail below.

FIG. 9 illustrates a calculation result of space potential distribution in an electrostatic field, when dielectrics (carriers) are placed between two parallel plates. The equation used for the calculation is a Laplace's equation, and the numerical analytic method used for the calculation is a general differential method (“simple spreadsheet based field calculation”, the 59th lecture meeting of the Imaging Society of Japan).

As illustrated in FIG. 9, dielectrics (carriers) are placed in a space between two parallel plates. When a voltage is applied between the parallel plates, the intervals of equipotential lines become sparse in the inside region of each dielectric (carrier) because the dielectric constant is larger. As a result, the intervals of equipotential lines become dense in a space between the parallel plate (photosensitive member) and a leading end of the dielectric (carrier). More specifically, it is believed that toner particles contained in the magnetic brush are subjected to the strong electric field if they are positioned closely to the photosensitive member. Thus, when the amount of toners increases due to the function of the strong electric field, it is believed that a greater amount of toners can move to the photosensitive member 1 (see the above-mentioned action (1)).

Next, if the amount of toners decreases in the vicinity of the developing sleeve 41, the electric resistance of the developer decreases steeply. In general, the amount of toners greatly influences the electric resistance of the developer because the toner has a resistance higher than that of the magnetic carrier by five digits or more. If the electric resistance of the developer decreases, the electric field intensity can be further enhanced because the potential in the vicinity of the photosensitive member 1 becomes closer to the potential of the developing sleeve 41. As a result, it is believed that a greater amount of toner particles can move to the photosensitive member 1 (see the above-mentioned action (2)).

To realize both of the above-mentioned actions (1) and (2), the conductive member 7 is disposed so as to be opposed to the toner urging pole N2, which is located odd-number pole upstream of the developing pole S1 (corresponding to the developing area D) in the rotational direction of the developing sleeve 41. Further, at least in an image forming operation, the image forming apparatus applies the voltage Vp to cause the toner particles to move from the conductive member 7 side to the developing sleeve 41 side.

As mentioned above, according to the present exemplary embodiment, the image forming apparatus calculates the ratio of the differential potential ΔV to the developing contrast potential Vcont, and controls the voltage to be applied to the conductive member 7 based on the calculated value. In particular, in the present exemplary embodiment, the image forming apparatus controls the voltage to be applied to the conductive member 7 based on a detection result of the ratio ΔV/Vcont obtained by the potential detection unit. Thus, in a case where the differential potential ΔV increases due to the deterioration of developer, it is feasible to suppress the defectiveness of the void by decreasing the ratio ΔV/Vcont. Accordingly, it is feasible to assure stable image quality in a long-term usage of the image forming apparatus without being adversely influenced by the “void.”

In this case, to cause the toner particles to move from the conductive member 7 side to the developing sleeve 41 side, the voltage Vp having the polarity identical to the toner charging polarity (negative polarity in the present exemplary embodiment) in the developing operation and the absolute value greater than the developing DC bias potential Vdc, is applied to the conductive member 7. More specifically, the image forming apparatus increases the DC component of the toner urging bias potential, compared to the developing DC bias potential, toward the toner charging polarity side in the developing operation. In the present exemplary embodiment, the toner urging bias potential is a DC voltage. However, the toner urging bias potential may be an oscillating voltage including an AC component superposed with a DC component.

In the present exemplary embodiment, the developing power source 8 and the toner urging power source 9 constitute a potential difference forming unit configured to form a potential difference that causes the toner particles of the developer brushes formed by the toner urging pole on the developer carrier to move from the conductive member side to the developer carrier side.

Further, magnetic poles sequentially disposed in the rotational direction of the developing sleeve, at least in the region extending from the developing pole (corresponding to the developing area) to the toner urging pole positioned on the upstream side, have alternately reversed polarities. Further, when the toner urging pole is located odd-number pole upstream of the developing pole (corresponding to the developing area) in the rotational direction of the developing sleeve, the magnetic brushes can be repetitively turned upside down in accordance with the rotation of the developing sleeve. As a result, an increased amount of toners can be positioned in the vicinity of the photosensitive member, at the position corresponding to the developing pole. However, to convey the magnetic brushes to the position corresponding to the developing pole while holding the state of the toner particles having been moved to the vicinity of the developing sleeve at the position corresponding to the toner urging pole, it is desired to set the above-mentioned odd number to be equal to or less than 5. For example, it is desired that the above-mentioned odd number is 3 or 1, preferably 1. On the other hand, if the toner urging pole is located even-number pole upstream of the developing pole, the magnetic brushes repetitively cause rotating motions in the region extending from the position corresponding to the toner urging pole to the position corresponding to the developing pole. The amount of toners increases in the vicinity of the developing sleeve, in the developing area and the amount of toners decreases in the vicinity of the photosensitive member.

When only one of the above-mentioned actions (1) and (2) is demonstrated, similar effects cannot be obtained. More specifically, if the amount of toners contained in the developer is simply increased to obtain the above-mentioned action (1), the electric resistance of the developer so increases that the above-mentioned effects of the present exemplary embodiment cannot be obtained. Further, if the amount of toners is reduced to obtain the above-mentioned action (2), the amount of toners so decreases in the vicinity of the photosensitive member 1 that the above-mentioned effects of the present exemplary embodiment cannot be obtained.

The control sequence to change the voltage Vp according to the present exemplary embodiment is performed in the image formation standby state. However, the present invention is not limited to the above-mentioned control sequence. For example, it is useful to perform the voltage Vp changing control based on a predetermined image pattern (e.g., a differential potential measurement image) formed between two papers in a continuous image forming operation or in a non-image forming portion on the photosensitive member. Typically, the voltage Vp changing control can be performed at arbitrary timing when no image is formed. For example, in addition to the above-mentioned image formation standby state, the image forming apparatus does not form any image in a preliminary multi-rotation process during which a predetermined preparatory operation is performed, for example, when the power source is turned on or in the process of recovery from the sleep mode. Further, the image forming apparatus does not form any image in a preliminary rotation process during which a predetermined preparatory operation is performed after an image forming start instruction is input until writing of an image is performed based on actual image information. Further, the image forming apparatus does not form any image between two papers (i.e., between a preceding transfer material and a following transfer material) in a continuous image forming operation. Further, the image forming apparatus does not form any image in a post rotation process during which a predetermined finishing operation (preparatory operation) is performed after completing the image forming operation.

Further, in the present exemplary embodiment, the image forming apparatus calculates the developing contrast potential Vcont based on the pre-development exposed portion potential (V_{L}) measured by the pre-development potential sensor 122. More specifically, in the present exemplary embodiment, the pre-development potential sensor 122 and the post-development potential sensor 121 cooperatively constitute the potential detection unit configured to detect the pre-development and post-development potentials of a predetermined image formed on the image carrier. However, for example, in a case where the developing contrast potential Vcont does not cause a larger change, it is useful to store an initial value of the Vcont beforehand in an appropriate storage unit (e.g., the ROM 112 according to the present exemplary embodiment) so that the image forming apparatus can perform the control based on the initial value and the value ΔV measured by the post-development potential sensor 121. In this case, the storage unit (e.g., the ROM 112) storing the initial Vcont value and the post-development potential sensor 121 cooperatively constitute the potential detection unit configured to detect the pre-development and post-development potentials of a predetermined image formed on the image carrier.

Further, in the present exemplary embodiment, the conductive member is shaped to have a curvature substantially identical to the curvature of the outer cylindrical surface of the developing sleeve. However, the present invention is not limited to the above-mentioned example. Typically, similar to the present exemplary embodiment, it is useful that the conductive member is curved along the outer cylindrical surface of the developing sleeve, at least partly at a surface opposed to the outer cylindrical surface of the developing sleeve. Further, for example, a columnar or a cylindrical conductive member is employable as the conductive member 7 as illustrated in FIG. 10. In this case, the conductive member 7 has an outer diameter smaller than the outer diameter of the developing sleeve 41. Typically, an axis line direction of the conductive member 7 is substantially parallel to the rotational axis direction of the developing sleeve 41. Further, it is useful to provide a magnetic roller (i.e., a magnetic field generation unit) 72 fixedly disposed in the cylindrical conductive member 7, as illustrated in FIG. 11. In this case, a magnetic pole of the magnetic roller 72 provided in the conductive member 7, if it is opposed to the magnetic roller 42 provided in the developing sleeve 41, has a magnetic polarity different from that of an opposing magnetic pole located in the developing sleeve 41. Further, the developer regulating member (i.e., the regulating blade) 44 can be modified so as to operate as the conductive member 7 as illustrated in FIG. 12.

Further, in the present exemplary embodiment, the conductive member 7 is disposed so as to be brought into contact with the magnetic brushes M on the developing sleeve 41. However, the present invention is not limited to the above-mentioned example. If the function of an electric field capable of causing the toner particles t contained in the magnetic brushes M to move toward the developing sleeve 41 is available, the conductive member 7 can be disposed closely to the magnetic brushes M without directly contacting the magnetic brushes M.

Next, a second exemplary embodiment of the present invention is described in detail bellow. An image forming apparatus according to the present exemplary embodiment is similar to that described in the first exemplary embodiment in fundamental configuration and operations to be performed. Accordingly, elements identical or similar to those described in the first exemplary embodiment are denoted using the same reference numerals and redundant description thereof will be avoided.

FIG. 13 is a cross-sectional view illustrating a schematic configuration of an essential part of the image forming apparatus 100 according to the present exemplary embodiment. In the present exemplary embodiment, the image forming apparatus 100 includes an optical fiber patch sensor 131 (serving as an image density detection unit) instead of the post-development potential sensor 121 and the pre-development potential sensor 122 provided in the image forming apparatus 100 described with reference to FIG. 1 in the first exemplary embodiment. In the present exemplary embodiment, the optical fiber patch sensor 131 is attached to a lower part of the developing device 4 so that the amount of applied toners (i.e., the image density) of a toner image formed on the photosensitive member 1 can be measured on the downstream side of the developing area D in the moving direction of the surface of the photosensitive member 1.

The image forming apparatus 100 according to the present exemplary embodiment can perform the patch detection type ATR using the optical fiber patch sensor 131. The patch detection type ATR is characterized by causing the optical fiber patch sensor to detect the density of a patch image (i.e., a toner image of a predetermined image pattern) formed on a carrier, such as the photosensitive member or the intermediate transfer belt. The developer toner density is determined based on a detection result of the optical fiber patch sensor, and the toner replenishment can be controlled based on the determined developer toner density. The developer toner density is a ratio of the weight of toner particles to the entire weight of the developer including toner particles and carrier particles (hereinafter, referred to as “ratio T/D”).

More specifically, in the first exemplary embodiment, the post-development potential sensor 121 and the pre-development potential sensor 122 are used as the void detection unit configured to measure the differential potential ΔV to calculate the ratio of the differential potential ΔV to the developing contrast potential Vcont and predict the void level. On the other hand, the image forming apparatus according to the present exemplary embodiment is characterized in that the optical fiber patch sensor employed for the patch detection type ATR is operable as the void detection unit configured to directly measure the void level.

Next, the voltage Vp changing control according to the present exemplary embodiment is described in detail bellow with reference to a flowchart illustrated in FIG. 14.

In the present exemplary embodiment, in step S201, the CPU 111 starts the voltage Vp changing control if use history information about the developing device 4 indicates that the number of image formed sheets exceeds a predetermined value in an ordinary image formation standby state.

First, in step S202, the CPU 111 causes the image forming apparatus to form a predetermined image pattern (hereinafter, referred to as “void evaluation image”) as a test image on the photosensitive member 1. In the present exemplary embodiment, the image pattern is a “void” evaluation image pattern that includes the HD image portion (i.e., the solid image portion) following immediately after the HT image portion (i.e., the halftone image portion), which has been described with reference to FIGS. 30A and 30B. The image pattern can be formed to have an arbitrary size suitable for the detection using the optical fiber patch sensor 131, within an image formable range in the longitudinal direction (i.e., the rotational axis direction) of the photosensitive member 1. Setting values stored beforehand in the ROM 112 of the control unit 110 are usable as image forming conditions including the exposure amount.

Next, in step S203, the CPU 111 causes the optical fiber patch sensor 131 to measure the image density of a post-development void evaluation image. FIG. 16 illustrates the output of the optical fiber patch sensor 131 that measures the void evaluation image, in which a solid line indicates a sensor output value in the developer deteriorated condition and a dotted line indicates a sensor output value in the initial (i.e., developer non-deteriorated) condition. In the present exemplary embodiment, the optical fiber patch sensor 131 irradiates the toner image with detection light and receives the regular reflection light. Then, the optical fiber patch sensor 131 outputs a signal representing the quantity of received light. Therefore, the output value corresponding to the HD image is relatively smaller than the output value corresponding to the HT image. However, in the developer deteriorated condition, the optical fiber patch sensor 131 generates an output corresponding to the “void” that is greater than the output corresponding to the HT image, between the output corresponding to the HT image and the output corresponding to the HD image. The initial measurement result of the void evaluation image obtained by the optical fiber patch sensor 131 is stored beforehand in the ROM 112.

Next, in step S204, the CPU 111 calculates a difference between an initial output value of the optical fiber patch sensor 131 (see a dotted line curve illustrated in FIG. 16) and an output value of the optical fiber patch sensor 131 in the developer deteriorated condition (see a solid line curve in illustrated in FIG. 16), as a void area.

Next, in step S205, the CPU 111 determines whether the above-mentioned void area is greater than 100. The permissible level of the “void” is variable depending on the configuration (e.g., product spec) of the image forming apparatus. Therefore, the threshold value of the void area is not limited to 100.

If it is determined that the void area is equal to or less than 100 (“NO” in step S205), then in step S207, the CPU 111 determines to use the previous setting values and terminates the processing of the flowchart illustrated in FIG. 14 without changing the voltage Vp to be applied to the conductive member 7.

On the other hand, if it is determined that the void area is greater than 100 (“YES” in step S205), then in step S206, the CPU 111 changes the voltage Vp to a desired value with reference to a table stored beforehand in the ROM 112. Subsequently, in step S207, the CPU 111 terminates the processing of the flowchart illustrated in FIG. 14.

The void area correlates with the ratio ΔV/Vcont described in the first exemplary embodiment. Further, as described in the first exemplary embodiment, a required voltage Vp corresponding to each ratio ΔV/Vcont can be obtained beforehand (see FIG. 7). Accordingly, a required voltage Vp corresponding to each void area can be obtained beforehand. In this case, similar to FIG. 7, a required table in determining the voltage Vp can be stored in the ROM 112.

As another method, the processing flow can be modified as illustrated in FIG. 15 to cause the CPU 111 to perform the processing in step S202 again after changing the voltage Vp in step S206 and repetitively perform the processes of calculating the void area and changing the voltage Vp until it is determined that the void area is equal to or less than 100. In this case, in step S206, the CPU 111 can change the voltage Vp by a predetermined change width having been set beforehand (typically, the voltage Vp is increased toward the toner charging polarity side in the developing operation). Thus, the CPU 111 can accurately set the voltage Vp to a desired value. In the flowchart illustrated in FIG. 15, processing identical or similar to that described in the flowchart illustrated in FIG. 14 is denoted using the same step number. Further, it is desired to perform conventional image density control in addition to the above-mentioned control of the void area. More specifically, the CPU 111 forms a void image pattern (step S202 illustrated in FIG. 15) after changing the voltage Vp to a desired value (step S206 illustrated in FIG. 15). Then, the CPU 111 measures an image density in addition to the measurement of the void area. More specifically, the CPU 111 causes the optical fiber patch sensor 131 to measure the density of a patch image (i.e. a toner image of the void image). Through the above-mentioned measurement, if it is determined that the void area is equal to or less than 100 and the image density is within a desired range, the CPU 111 terminates the processing of the flowchart without further changing the settings. On the other hand, if it is determined that the image density is outside the desired range although the void area is equal to or less than 100, the CPU 111 adjusts the voltage Vp within a range in which the void area does not exceed 100 and controls the image density. In this case, a conventional image density controlling method is employable to control the image density. For example, the conventional image density controlling method includes adjusting the developer toner density through toner replenishment or discharge and adjusting the image density by changing the toner charging amount (tribo). Further, it is useful to employ another method that includes changing the photosensitive member or developing bias potential settings to adjust the developing contrast potential Vcont so as to adjust the image density.

More specifically, the image forming apparatus 100 according to the present exemplary embodiment includes the image density detection unit 131 that is operable as a void detection unit configured to detect a post-development image density of a predetermined image formed on the image carrier. Further, the image forming apparatus 100 according to the present exemplary embodiment includes the CPU 111 that is operable as a changing unit configured to change the voltage to be applied from the toner urging power source 9 to the conductive member 7 based on a detection result obtained by the image density detection unit 131. The CPU 111 (i.e., the changing unit) changes the voltage to be applied from the toner urging power source 9 to the conductive member 7 based on a difference between image density information about the above-mentioned predetermined image detected by the image density detection unit 131 and predetermined image density information obtained beforehand. More specifically, in the present exemplary embodiment, if the above-mentioned difference value is greater than a predetermined value, the CPU 111 changes the voltage to be applied from the toner urging power source 9 to the conductive member 7. Typically, the CPU 111 increases the voltage to be applied from the toner urging power source 9 to the conductive member 7 toward the toner charging polarity side in the developing operation, with reference to the above-mentioned table, when the above-mentioned difference value becomes larger.

The control terminates after the above-mentioned processing. The image forming apparatus performs ordinary image forming operations using the changed voltage Vp. When the differential potential ΔV increases with deteriorating developer, the ratio ΔV/Vcont can be deduced and the defectiveness of the void can be suppressed by repetitively performing the above-mentioned operation. Accordingly, it is feasible to assure stable image quality in a long-term usage of the image forming apparatus without being adversely influenced by the “void.”

As mentioned above, the image forming apparatus according to the present exemplary embodiment measures the void area and controls the voltage to be applied to the conductive member 7 based on the measured value. In particular, the image forming apparatus according to the present exemplary embodiment causes the image density detection unit to detect a variation in image density compared to the initial state, and controls the voltage to be applied to the conductive member 7 based on the detected variation. Thus, the image forming apparatus according to the present exemplary embodiment can obtain effects similar to those described in the first exemplary embodiment.

The control sequence to change the voltage Vp according to the present exemplary embodiment is performed in the image formation standby state. However, the present invention is not limited to the above-mentioned control sequence. For example, it is useful to perform the voltage Vp changing control based on a predetermined image pattern (e.g., a void evaluation image) formed between two papers in a continuous image forming operation or in a non-image forming portion on a carrier, such as the photosensitive member or the intermediate transfer belt.

Further, in the present exemplary embodiment, the optical fiber patch sensor 131 is used to detect the density of a patch image formed on the photosensitive member 1. However, it is useful to detect the density of a patch image on a carrier (e.g., the intermediate transfer belt 51).

Next, a third exemplary embodiment of the present invention is described in detail bellow. An image forming apparatus according to the present exemplary embodiment is similar to that described in the first exemplary embodiment in fundamental configuration and operations to be performed. Accordingly, elements identical or similar to those described in the first exemplary embodiment are denoted using the same reference numerals and redundant description thereof will be avoided.

FIG. 17 is a cross-sectional view illustrating a schematic configuration of an essential part of the image forming apparatus 100 according to the present exemplary embodiment. In the present exemplary embodiment, the image forming apparatus 100 includes an inductance sensor (i.e., an inductance head) 141 instead of the post-development potential sensor 121 and the pre-development potential sensor 122 provided in the image forming apparatus 100 described with reference to FIG. 1 in the first exemplary embodiment. The inductance sensor 141 is a toner density detection unit configured to detect the toner density (i.e., ratio T/D) of the developer stored in the developing device 4. In the present exemplary embodiment, the inductance sensor 141 is attached to a bottom portion of the developer container 46 of the developing device 4. Further, in the present exemplary embodiment, the image forming apparatus 100 includes a counter 114 provided in the control unit 110. The counter 114 is a storage device that is operable as a history detection unit configured to add up the number of image outputting sheets and store the counted value. Every time when the image forming apparatus 100 outputs an image, the counter 114 sequentially adds up the number of image outputting sheets and stores the counted value. The history information to be detected by the history detection unit is not limited to the number of image outputting sheets, and therefore can be any other information that correlates with the number of image outputting sheets. For example, the rotational speed (or rotating time) of the developing sleeve or the rotational speed (or rotating time) of the photosensitive member is employable as the history information.

The image forming apparatus 100 according to the present exemplary embodiment can perform inductance detection type ATR using the inductance sensor 141. The inductance detection type ATR is characterized by causing the inductance sensor to detect a dummy magnetic permeability of the developer based on differences in magnetic permeability between non-magnetic toner particles and magnetic carrier particles to determine the developer toner density (i.e., ratio T/D). The image forming apparatus 100 performs toner replenishment control according to the determined toner density.

More specifically, in the first exemplary embodiment, the post-development potential sensor 121 and the pre-development potential sensor 122 are used as the void detection unit configured to measure the differential potential ΔV to calculate the ratio of the differential potential ΔV to the developing contrast potential Vcont and predict the void level. On the other hand, the image forming apparatus according to the present exemplary embodiment is characterized in that the inductance sensor employed for the inductance detection type ATR is operable as the void detection unit configured to measure the deterioration degree of the developer and predict the void level.

Next, voltage Vp changing control according to the present exemplary embodiment is described in detail bellow with reference to a flowchart illustrated in FIG. 18.

In the present exemplary embodiment, in step S301, the CPU 111 starts the voltage Vp changing control if use history information about the developing device 4 indicates that the number of image formed sheets exceeds a predetermined value in an ordinary image formation standby state.

First, in step S302, the CPU 111 causes the inductance sensor 141 to measure a dummy magnetic permeability of the developer stored in the developing device 4. FIG. 19 illustrates a relationship between the ratio T/D of the developer and the output value of the inductance sensor 141. In FIG. 19, if the dummy magnetic permeability is converted into an electric signal, the electric signal varies substantially linearly according to the ratio T/D of the developer. The relationship between the ratio T/D of the developer and the output value of the inductance sensor 141 illustrated in FIG. 19 is stored beforehand in the ROM 112.

Next, in step S303, the CPU 111 calculates a ratio T/D value based on the converted electric signal with reference to the relationship between the ratio T/D of the developer and the output value of the inductance sensor 141 (see FIG. 19), which is stored in the ROM 112.

FIG. 20 illustrates a calculation result of a relationship between the number of output sheets and ratio T/D about a 50% duty ratio (i.e., image ratio or printing rate) image. The ratio T/D reaches a lower-limit value (6% in the present exemplary embodiment) when the number of output sheets is approximately 30. The image forming apparatus starts toner replenishment and continuously performs the toner replenishment until the ratio T/D reaches an upper-limit value (10% in the present exemplary embodiment). It is generally known that the physical abrasion induces the deterioration of developer, for example, when toner particles and carrier particles are stirred together and pass by the developer regulating member. More specifically, in FIG. 20, it is believed that the deterioration of developer is accelerated in a period “ns” in which no toner replenishment is performed. FIG. 21 illustrates the gradient of ratio T/D in relation to the number of image outputting sheets. When the gradient of ratio T/D is equal to or less than 0, it is presumed that no toner replenishment is performed or the toner replenishment amount is smaller. Therefore, in the present exemplary embodiment, the CPU 111 calculates the gradient of ratio T/D. If the calculated T/D gradient is equal to or less than 0, the CPU 111 changes the voltage Vp according to the number of output sheets.

More specifically, referring back to the flowchart illustrated in FIG. 18, in step S304, the CPU 111 calculates a T/D gradient value based on information about the ratio T/D calculated as mentioned above and the number of image outputting sheets stored in the counter 114.

Next, in step S305, the CPU 111 determines whether the gradient of ratio T/D is equal to or less than 0.

If it is determined that the gradient of ratio T/D is greater than 0 (“NO” in step S305), then in step S307, the CPU 111 determines to use the previous setting values and terminates the processing of the flowchart illustrated in FIG. 18 without changing the voltage Vp to be applied to the conductive member 7.

On the other hand, if it is determined that the gradient of ratio T/D is equal to or less than 0 (YES in step S305), then in step S306, the CPU 111 changes the voltage Vp to a desired value according to the number of output sheets with reference to the table stored beforehand in the ROM 112. Subsequently, in step S307, the CPU 111 terminates the processing of the flowchart illustrated in FIG. 18.

FIG. 22 illustrates a relationship between the number of output sheets and the voltage Vp, which can be used in step S306. According to the relationship illustrated in FIG. 22, the absolute value of the voltage Vp becomes greater when the number of output sheets increases. The deterioration degree of the developer correlates with the number of output sheets. Therefore, the number of output sheets correlates with the ratio ΔV/Vcont described in the first exemplary embodiment. Further, as described in the first exemplary embodiment, a required voltage Vp corresponding to each ratio ΔV/Vcont can be obtained beforehand (see FIG. 7). Accordingly, a required voltage Vp corresponding to each number of output sheets can be obtained beforehand as illustrated FIG. 22. A required table in determining the voltage Vp can be stored in the ROM 112.

In the present exemplary embodiment, the CPU 111 changes the voltage Vp according to the number of output sheets to be reset every time when the gradient of ratio T/D becomes equal to or less than 0 (i.e., at the beginning of the voltage Vp change period). In a period in which the gradient of ratio T/D is greater than 0 and therefore the voltage Vp is not changed, the CPU 111 can bring the conductive member 7 into a floating state (in which no voltage Vp is applied) or can apply a predetermined constant Vp (≈Vdc) to the conductive member 7. Further, as another method, after the gradient of ratio T/D becomes equal to or less than 0 (i.e., in the voltage Vp change period), the CPU 111 can change the voltage Vp according to the cumulative number of output sheets (i.e., a value added up since the initial usage state of the developer).

More specifically, the image forming apparatus 100 according to the present exemplary embodiment includes the history detection unit 114 configured to detect information relating to the number of image outputting sheets. Further, the image forming apparatus 100 according to the present exemplary embodiment includes the CPU 111 that is operable as the changing unit configured to change the voltage to be applied from the toner urging power source 9 to the conductive member 7 based on a detection result obtained by the history detection unit 114. Typically, the CPU 111 (i.e. the changing unit) increases the voltage to be applied from the toner urging power source 9 to the conductive member 7 toward the toner charging polarity side in the developing operation in response to an increase of the value correlating with the number of image outputting sheets, which is represented by a detection result obtained by the history detection unit 114. Further, the image forming apparatus 100 according to the present exemplary embodiment includes the toner density detecting unit 141 configured to detect the toner density of the developer. Further, the CPU 111 changes the voltage to be applied from the toner urging power source 9 to the conductive member 7 in a period during which the toner density of the developer detected by the toner density detecting unit 141 decreases.

The control terminate after the above-mentioned processing. The image forming apparatus performs ordinary image forming operations using the changed voltage Vp. When the differential potential ΔV increases with deteriorating developer, the ratio ΔV/Vcont can be deduced and the defectiveness of the void can be suppressed by repetitively performing the above-mentioned operation. Accordingly, it is feasible to assure stable image quality in a long-term usage of the image forming apparatus without being adversely influenced by the “void.”

As mentioned above, the image forming apparatus according to the present exemplary embodiment causes the inductance sensor 141 and the history detection unit 114 to predict the deterioration degree of the developer and controls the voltage to be applied to the conductive member 7 based on the predicted value. In particular, the image forming apparatus according to the present exemplary embodiment controls the voltage to be applied to the conductive member 7 based on the value correlating with the number of image outputting sheets obtained by the history detection unit 114. Thus, it is feasible to obtain effects similar to those described in the first and second exemplary embodiments. Further, the image forming apparatus according to the present exemplary embodiment can effectively control the voltage to a desired value according to an actual deterioration degree of the developer, by changing the voltage to be applied to the conductive member 7 in a period during which the deterioration of developer is accelerated.

The control sequence to change the voltage Vp according to the present exemplary embodiment is performed in the image formation standby state. However, the present invention is not limited to the above-mentioned control sequence. For example, it is useful to perform the voltage Vp changing control between two papers in a continuous image forming operation. Further, similar to the first and second exemplary embodiments, it is desired to control the image density in addition to the above-mentioned control. In this case, a conventional image density controlling method is employable to control the image density. For example, the conventional image density controlling method includes adjusting the developer toner density through toner replenishment or discharge and adjusting the image density by changing the toner charging amount (tribo). Further, it is useful to employ another method that includes changing the photosensitive member or developing bias potential settings to adjust the developing contrast potential Vcont so as to adjust the image density.

Next, a fourth exemplary embodiment of the present invention is described in detail bellow. An image forming apparatus according to the present exemplary embodiment is similar to that described in the first exemplary embodiment in fundamental configuration and operations to be performed. Accordingly, elements identical or similar to those described in the first exemplary embodiment are denoted using the same reference numerals and redundant description thereof will be avoided.

FIG. 23 is a cross-sectional view illustrating a schematic configuration of an essential part of the image forming apparatus 100 according to the present exemplary embodiment. In the present exemplary embodiment, the image forming apparatus 100 includes an optical sensor 151 instead of the post-development potential sensor 121 and the pre-development potential sensor 122 provided in the image forming apparatus 100 described with reference to FIG. 1 in the first exemplary embodiment. The optical sensor 151 is a toner density detection unit configured to detect the toner density (i.e., ratio T/D) of the developer stored in the developing device 4. In the present exemplary embodiment, the optical sensor 151 is attached to an upper portion of the developer container 46 of the developing device 4.

The image forming apparatus 100 according to the present exemplary embodiment can perform light detection type ATR using the optical sensor 151. The light detection type ATR is characterized by causing the image sensor to detect a quantity of light reflected from the developer based on characteristics that carrier particles absorb infrared light reflected from toner particles, to determine the developer toner density (i.e., ratio T/D). The image forming apparatus 100 performs toner replenishment control according to the determined toner density.

More specifically, in the first exemplary embodiment, the post-development potential sensor 121 and the pre-development potential sensor 122 are used as the void detection unit configured to measure the differential potential ΔV to calculate the ratio of the differential potential ΔV to the developing contrast potential Vcont and predict the void level. On the other hand, the image forming apparatus according to the present exemplary embodiment is characterized in that the image sensor employed for the light detection type ATR is operable as the void detection unit configured to measure the deterioration degree of the developer and predict the void level, similar to the third exemplary embodiment.

Next, a voltage Vp changing control according to the present exemplary embodiment is described in detail bellow with reference to a flowchart illustrated in FIG. 24.

In the present exemplary embodiment, in step S401, the CPU 111 starts the voltage Vp changing control if use history information about the developing device 4 indicates that the number of image formed sheets exceeds a predetermined value in an ordinary image formation standby state.

First, in step S402, the CPU 111 causes the optical sensor 151 to measure the quantity of light reflected from the developer stored in the developing device 4. FIG. 25 illustrates a relationship between the ratio T/D of the developer and the output value of the optical sensor 151. In FIG. 25, if the quantity of reflected light is converted into an electric signal, the electric signal varies substantially linearly according to the ratio T/D of the developer. The relationship between the ratio T/D of the developer and the output value of the optical sensor 151 illustrated in FIG. 25 is stored beforehand in the ROM 112.

Next, in step S403, the CPU 111 calculates a ratio T/D value based on the converted electric signal with reference to the relationship between the ratio T/D of the developer and the output value of the optical sensor 151 (FIG. 25), which is stored in the ROM 112.

Next, in step S404, the CPU 111 calculates a T/D gradient value based on information about the ratio T/D and the number of output sheets, similar to the third exemplary embodiment.

Next, in step S405, the CPU 111 determines whether the gradient of ratio T/D is equal to or less than 0.

If it is determined that the gradient of ratio T/D is greater than 0 (NO in step S405), then in step S407, the CPU 111 determines to use the previous setting values and terminates the processing of the flowchart illustrated in FIG. 24 without changing the voltage Vp to be applied to the conductive member 7.

On the other hand, if it is determined that the gradient of ratio T/D is equal to or less than 0 (YES in step S405), then in step S406, the CPU 111 changes the voltage Vp according to the number of output sheets with reference to the table stored beforehand in the ROM 112, similar to the third exemplary embodiment. Subsequently, in step S407, the CPU 111 terminates the processing of the flowchart illustrated in FIG. 24.

The control terminates after the above-mentioned processing. The image forming apparatus performs ordinary image forming operations using the changed voltage Vp. When the differential potential ΔV increases with deteriorating developer, the ratio ΔV/Vcont can be deduced and the defectiveness of the void can be suppressed by repetitively performing the above-mentioned operation. Accordingly, it is feasible to assure stable image quality in a long-term usage of the image forming apparatus without being adversely influenced by the “void.” Further, similar to the third exemplary embodiment, the image forming apparatus according to the present exemplary embodiment can control the voltage Vp to a desired value according to an actual deterioration degree of developer, by changing the voltage Vp in a period during which the deterioration of developer is accelerated.

The control sequence to change the voltage Vp according to the present exemplary embodiment is performed in the image formation standby state. However, the present invention is not limited to the above-mentioned control sequence. For example, it is useful to perform the voltage Vp changing control between two papers in a continuous image forming operation. Further, similar to the first and second exemplary embodiments, it is desired to control the image density in addition to the above-mentioned control. In this case, a conventional image density controlling method is employable to control the image density. For example, the conventional image density controlling method includes adjusting the developer toner density through toner replenishment or discharge and adjusting the image density by changing the toner charging amount (tribo). Further, it is useful to employ another method that includes changing the photosensitive member or developing bias potential settings to adjust the developing contrast potential Vcont so as to adjust the image density.

Next, a fifth exemplary embodiment of the present invention is described in detail bellow. An image forming apparatus according to the present exemplary embodiment is similar to that described in the first exemplary embodiment in fundamental configuration and operations to be performed. Accordingly, elements identical or similar to those described in the first exemplary embodiment are denoted using the same reference numerals and redundant description thereof will be avoided.

FIG. 26 is a cross-sectional view illustrating a schematic configuration of an essential part of the image forming apparatus 100 according to the present exemplary embodiment. In the present exemplary embodiment, the image forming apparatus 100 enables a user to directly change the voltage Vp. More specifically, the image forming apparatus 100 according to the present exemplary embodiment includes an operation unit 161 (i.e., an input unit) operable to directly change the voltage Vp.

First, the CPU 111 causes the image forming apparatus to output, as a test chart, a “void” evaluation image including the HD image portion (i.e., the solid image portion) following immediately after the HT image portion (i.e., the halftone image portion), which has been described with reference to FIGS. 30A and 30B, on the transfer material P according to a user instruction input via the operation unit 161. Then, the user visually evaluates a generation degree of the “void” in the test chart. The user can operate the image forming apparatus to output the test chart at arbitrary timing (e.g., image formation standby state).

If the user recognizes the defectiveness of the “void”, the user operates the operation unit 161 to input instruction to change the voltage Vp. FIG. 27 illustrates an example of the operation unit 161 that is operable to change the voltage Vp. The operation unit 161 allows the user to select an arbitrary index from a plurality of stages (e.g., 1 to 10). FIG. 28 is a graph illustrating a relationship between the selectable index stage and the voltage Vp, which is stored beforehand in the ROM 112. The CPU 111 determines the voltage Vp according to an index selected by the user with reference to the stored information.

As mentioned above, the image forming apparatus 100 according to the present exemplary embodiment includes the operation unit 161. Further, the image forming apparatus 100 according to the present exemplary embodiment includes the CPU 111, which is operable as a changing unit configured to change the voltage to be applied from the toner urging power source 9 to the conductive member 7 based on an instruction input via the operation unit 161.

As described above, the image forming apparatus according to the present exemplary embodiment can obtain, at arbitrary timing, an image stable in image density without being adversely influenced by the “void” according to a user request.

The present exemplary embodiment is applicable in addition to, or instead of using, any control described in the above-mentioned exemplary embodiments. More specifically, for example, it is useful to provide a manual mode to allow a user to arbitrarily change the voltage to be applied to the conductive member 7, so that the user can arbitrarily select a level of image quality to be output according to user preference.

Further, in the present exemplary embodiment, the operation unit 161 provided in the image forming apparatus 100 allows a user to input an instruction to change the voltage Vp. However, the present invention is not limited to the above-mentioned configuration. For example, it is useful to provide an external apparatus (e.g., a personal computer) that can communicate with the image forming apparatus 100 to enable a user to instruct the control unit 110 to change the voltage Vp.

### Other Exemplary Embodiments

The present invention is not limited to the above-mentioned exemplary embodiments.

For example, if necessary to maintain the image quality, it is useful to perform conventional density stabilizing control in addition to the control described in the above-mentioned exemplary embodiment. The density stabilizing control is, for example, toner replenishment control using the image density detection unit (optical fiber patch sensor), such as an optical sensor, or the toner density detection unit (capable of detecting the toner density of the developer stored in the developing device), such as an inductance detection sensor.

Further, if the ratio ΔV/Vcont satisfies the threshold value condition in a case where a sufficient amount of applied toners can be secured (for example, in the initial state), the CPU 111 can bring the conductive member 7 into a floating state (in which no voltage Vp is applied).

Further, the toner density detection unit (capable of detecting the toner density of the developer stored in the developing device) employed in the third and fourth exemplary embodiments is the optical fiber patch sensor provided for the patch detection type ATR or the inductance sensor provided for the inductance detection type ATR. However, the toner density detection unit is not limited to the above-mentioned example. For example, it is useful to employ conventional video count ATR to calculate a ratio T/D value and perform the voltage Vp changing control based on the calculated ratio T/D. The video count ATR is characterized by obtaining a toner consumption amount based on formed image information (e.g., cumulative density value for each pixel) to calculate a ratio T/D value and performing toner replenishment control based on the calculated ratio T/D.

According to the present invention, it becomes feasible to decrease the ratio ΔV/Vcont according to the void level when the differential potential ΔV increases with deteriorating developer. Accordingly, it is feasible to assure stable image quality in a long-term usage of the image forming apparatus without being adversely influenced by the “void.”

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-054383 filed Mar. 15, 2013, which is hereby incorporated by reference herein in its entirety.

What is claimed is:

1. An image forming apparatus comprising;
an image carrier on which an electrostatic image can be formed;
a rotatable developer carrier that can carry and convey a developer containing toner particles and carrier particles to supply the toner particles to the image carrier at a developing area to develop the electrostatic image formed thereon;
a magnetic field generation member that is fixedly disposed in a hollow part of the developer carrier and includes a plurality of magnetic poles disposed in a circumferential direction of the developer carrier;
a conductive member disposed so as to oppose a predetermined magnetic pole, of the plurality of magnetic poles, which is located odd-number pole upstream of a magnetic pole corresponding to the developing area in a rotational direction of the developer carrier;
a power source that can apply a voltage to the conductive member;
a potential detecting device configured to detect a potential on the image carrier; and
a control unit configured to control the voltage to be applied from the power source to the conductive member based on pre-development and post-development potential information about a predetermined latent image pattern formed on the image carrier.

2. The image forming apparatus according to claim 1, wherein the control unit is configured to control the voltage to be applied from the power source to the conductive member according to a ratio (ΔV/Vcont) of a potential difference (ΔV) between a DC component potential of a developing voltage applied to the developer carrier and a post-development potential of a predetermined latent image pattern detected by a potential detection unit to a potential difference (Vcont) between the DC component potential of the developing voltage and a pre-development potential of the predetermined latent image pattern detected by the potential detection unit.

3. The image forming apparatus according to claim 2, wherein the control unit is configured to change the voltage to be applied from the power source to the conductive member if the ratio is greater than a predetermined value.

4. The image forming apparatus according to claim 2, wherein the control unit is configured to increase the voltage to be applied from the power source to the conductive member toward a toner charging polarity side in a developing operation if a value represented by the difference becomes larger.

5. An image forming apparatus comprising:
an image carrier on which an electrostatic image can be formed;
a rotatable developer carrier that can carry and convey a developer containing toner particles and carrier particles to supply the toner particles to the image carrier at a developing area to develop the electrostatic image formed thereon;
a magnetic field generation member that is fixedly disposed in a hollow part of the developer carrier and includes a plurality of magnetic poles disposed in a circumferential direction of the developer carrier;
a conductive member disposed so as to oppose a predetermined magnetic pole, of the plurality of magnetic poles, which is located odd-number pole upstream of a magnetic pole corresponding to the developing area in a rotational direction of the developer carrier;
a power source that can apply a voltage to the conductive member;
an image density detecting device configured to detect the density of the image formed on the image carrier; and
a control unit configured to control the voltage to be applied from the power source to the conductive member based on a detection result obtained by the image density detection unit.

6. The image forming apparatus according to claim 5, wherein the control unit is configured to change the voltage to be applied from the power source to the conductive member according to a difference between the detection result obtained by the image density detecting device and predetermined image density information obtained beforehand.

7. The image forming apparatus according to claim 6, wherein the control unit is configured to change the voltage to be applied from the power source to the conductive member if a value represented by the difference is greater than a predetermined value.

8. The image forming apparatus according to claim 6, wherein the control unit is configured to increase the voltage to be applied from the power source to the conductive member toward a toner charging polarity side in a developing operation if a value represented by the difference becomes larger.

9. An image forming apparatus comprising:
an image carrier on which an electrostatic image can be formed;
a rotatable developer carrier that can carry and convey a developer containing toner particles and carrier particles to supply the toner particles to the image carrier at a developing area to develop the electrostatic image formed thereon;
a magnetic field generation member that is fixedly disposed in a hollow part of the developer carrier and includes a plurality of magnetic poles disposed in a circumferential direction of the developer carrier;
a conductive member disposed so as to oppose a predetermined magnetic pole, of the plurality of magnetic poles, which is located odd-number pole upstream of a magnetic pole corresponding to the developing area in a rotational direction of the developer carrier;
a power source that can apply a voltage to the conductive member; and
a control unit configured to control the voltage to be applied from the power source to the conductive member based on information relating to a number of image outputting sheets.

10. The image forming apparatus according to claim 1, wherein the predetermined magnetic pole forms developer brushes that stand on the developer carrier and contact the conductive member.

11. The image forming apparatus according to claim 1, wherein a potential difference is formed between the developer carrier and the conductive member, in an image forming operation, to cause toner particles contained in developer brushes formed by the predetermined magnetic pole on the developer carrier to move from a conductive member side to a developer carrier side.

12. The image forming apparatus according to claim 1, wherein a DC component potential of the voltage to be applied from the power source to the conductive member is higher than a DC component potential of a developing voltage applied to the developer carrier toward a toner charging polarity side in a developing operation.
